(19) United States
(12) Patent Application Publication
(10) Pub. No.: US 2011/0261963 A1
(43) Pub. Date: Oct. 27, 2011

(54) METHOD FOR SHARING AN INFORMATION CIPHERING AND DECIPHERING KEY, A KEY SHARING SYSTEM AND AN ACCESS CONTROL SYSTEM APPLYING THIS METHOD

(76) Inventor: Michael Adjedj, Bonneuil-Sur-Marne (FR)

(21) Appl. No.: 13/093,765

(22) Filed: Apr. 25, 2011

(30) Foreign Application Priority Data
Apr. 26, 2010 (FR) 10 53170

(51) Int. Cl. H04L 9/08

(52) U.S. Cl. 380/279

(57) ABSTRACT

This method is characterized in that it includes the following steps, a step for establishing a key root database in the transmitter and said at least one receiver, a step for generating in the transmitter a sequence of bits called an index, a step for having this index bit sequence transmitted by the transmitter to the receiver, and a step for having the key extracted from the index and from the key root database by the transmitter and said at least one receiver.

### CROSS-REFERENCE TO RELATED APPLICATIONS

This application claims benefit of French patent application number 10 53170, filed Apr. 26, 2010, which is herein incorporated by reference.

### BACKGROUND OF THE INVENTION

1. Field of the Invention

The present invention concerns a method for sharing an information ciphering/deciphering key between a transmitter and at least one receiver.

The invention also relates to a system for applying this method and to a system for controlling access to pay television signals, which includes at least such a system.

2. Description of the Related Art

Such methods enter the general scope of what is called cryptology.

Modern cryptology is a science which uses diverse techniques sometimes using complex mathematical theories, with the purpose of ensuring confidentiality of exchanges of information.

In a transmission of pieces of information, the latter circulate through a transmission channel for example formed by a telephone cable, internet, by a postal route, etc. . . . This channel is generally accessible to a great number of persons and the circulating pieces of information may be observed.

With the purpose of keeping this information secret, one generally resorts to cryptography.

Thus before being transmitted over a transmission channel, the pieces of information are subject to a transformation, called ciphering, which makes them incomprehensible to any observer of the channel.

Upon reception, the addressee carries out an inverse operation called deciphering, supposed to restore all its meaning to the received information.

These operations resort to keys, certain of which have to remain secret.

Two great kinds of cryptography are distinguished i. e.:

1) cryptography with a secret key, or symmetrical cryptography, where the ciphering and deciphering operations use the same key. The operations carried out within this scope are generally fast and require few resources. However they have a major drawback in that a secret key is required for each pair of users who wish to exchange pieces of information.

2) cryptography with a public key, or asymmetrical cryptography, where the ciphering and deciphering operations use different keys, most often related through an algebraic formula. With this technique, the number of required keys may be reduced.

There also exist ciphering schemes using both symmetrical and asymmetrical mechanisms. These schemes are described as hybrid schemes.

In the case of ciphered grouped dispatchings for multiple receivers also known as <<broadcast encryption>>, the management of the common keys may pose a certain number of problems especially when the latter have to be changed.

The major undesirable effect which may be observed, depending on the management of the users is an increased consumption of the allocated bandwidth upon any renewal of keys.

This is particular the case when for some reason or another, there is a need for changing keys in systems for controlling access to pay television signals for example.

It is indeed understood that the subscribers to such systems amount to hundreds of thousands and that renewal of the keys for each of them is extremely consuming notably in terms of bandwidth and time.

### SUMMARY OF THE INVENTION

The object of the invention is therefore to solve these problems.

For this purpose, the object of the invention is method for sharing an information ciphering/deciphering key between a transmitter and at least one receiver, characterized in that it includes the following steps:

a step for establishing in the transmitter and said at least one receiver, a key root database,

a step for generating in the transmitter a sequence of bits called an index,

a step for having this index bit sequence transmitted by the transmitter to the receiver, and

a step for extracting by the transmitter and at least one receiver, the key from the index and the key root database.

According to other aspects of the invention, the sharing method comprises one or more of the following features:

the step for establishing the key root database includes a step for generating the latter in the transmitter and a step for having the latter transmitted by the transmitter to the receiver,

the step for transmitting the key root database and/or the step for transmitting the index bit sequence are carried out over a secured channel between the transmitter and the receiver,

the step for establishing the key root database includes:

a step for generating in the transmitter, an information sequence called a seed,

a step for having this seed information sequence transmitted by the transmitter to the receiver, and

a step for having this seed information sequence derived from the key root database by the transmitter and the receiver,

the step for having the key root database derived by the transmitter and the receiver applies a cryptographic method,

the cryptographic method applies a hash function,

the cryptographic method applies a pseudo-random generator,

the transmission of the seed information sequence and/or the transmission of the index bit sequence are carried out over a secured channel,

the step for having the key extracted from the index and from the key root database by the transmitter and said at least one receiver is carried out by an injective derivation algorithm, and

the index bit sequence has a length of 32 or 64 bits and the key has a length of 128, 192 or 256 bits.

The invention also relates to a system for sharing an information ciphering/deciphering key between a transmitter and at least one receiver for applying such a method, characterized in that it includes:

means for establishing a key root database in the transmitter and said at least one receiver,

means for generating in the transmitter a sequence of bits called an index,

means for transmitting this index bit sequence by the transmitter to the receiver, and

means for having the key extracted from the index and from the key root database by the transmitter and said at least one receiver.

The invention finally relates to a system for controlling access to pay television signals, characterized in that it includes at least one system for sharing an information ciphering/deciphering key between a transmitter and at least one receiver.

### BRIEF DESCRIPTION OF THE DRAWINGS

The invention will be better understood from the description which follows only given as an example and made with reference to the appended drawings wherein:

FIG. 1 illustrates a block diagram illustrating a transmitter and receivers between which information is exchanged, and

FIG. 2 illustrates a flow chart illustrating the different steps of an exemplary embodiment of a sharing method according to the invention.

### DETAILED DESCRIPTION

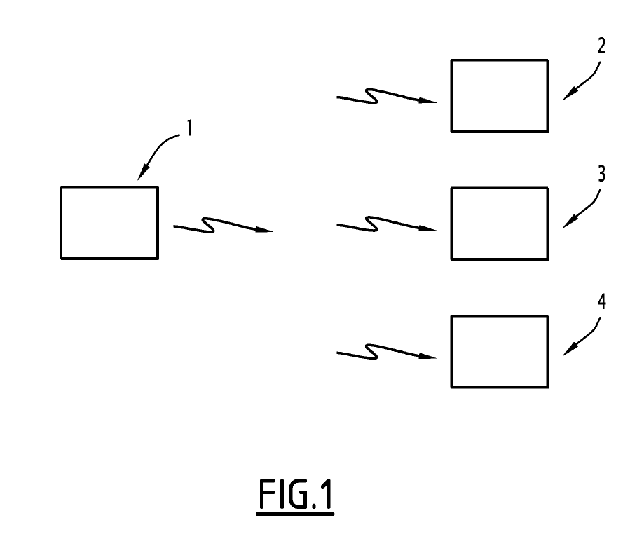

The invention actually relates to a method for sharing an information ciphering/deciphering key between a transmitter, designated by the general reference 1 in FIG. 1, and at least one receiver designated by the general reference 2 in this figure.

Of course, any number of receivers may be contemplated, three being illustrated in this figure and being designated by general references 2, 3 and 4 respectively in this FIG. 1.

These transmitter and receivers are for example integrated into a key sharing system as applied in a system for controlling access to pay television signals.

In such an exemplary embodiment, television signals are transmitted in ciphered form by means of a key, by a network head.

The ciphered signals are received at the receivers, which then use a deciphering key for recovering the signals and transmitting them in clear for example to a television set.

It is understood that in such an application, the keys should be regularly changed notably for adapting the receivers to modifications of subscriptions, cancellations, . . . or due to hacking problems, etc. . . .

Now, as the number of relevant receivers, i.e. for example the number of subscribers to such a system amounts to tens or even hundreds of thousands, it is understood that the renewal operations for these keys are tedious and long and consume a very large bandwidth.

Indeed, such ciphering/deciphering keys may for example presently have a length of 128 or 256 bits.

In order to solve these problems, the present invention proposes a class of algorithms allowing in a cryptographic and secure way, diversification of the symmetrical keys with cryptographic sizes generally with a length of 128, 192 or 256 bits, from a much smaller index, typically of the order of 32 or 64 bits.

Of course, different lengths may be contemplated depending on the mechanism used.

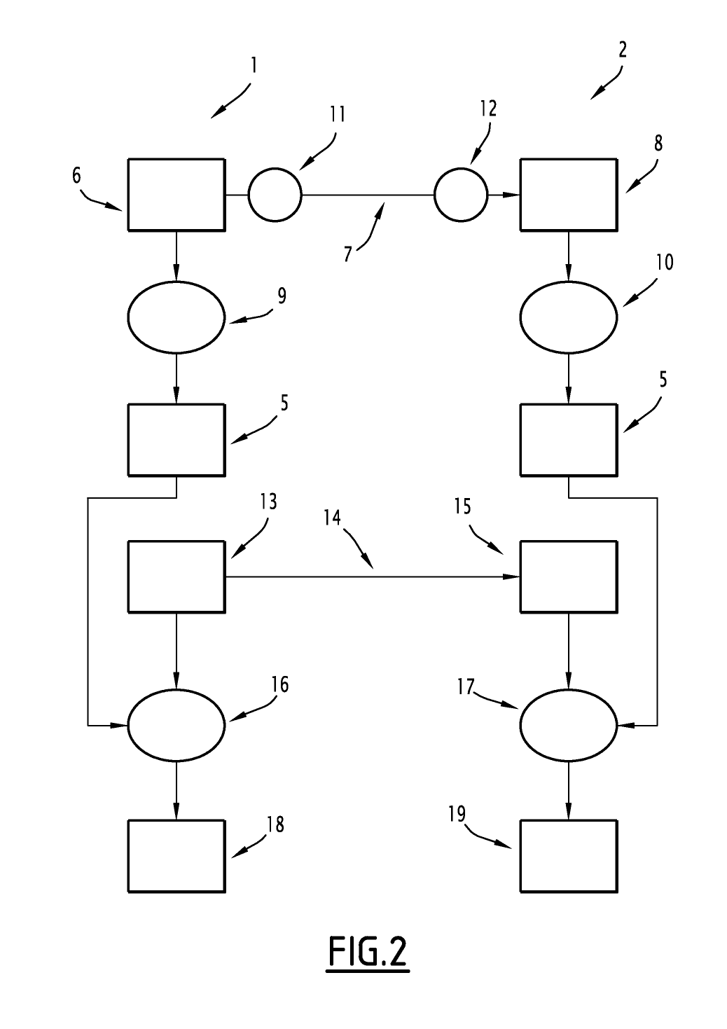

For this purpose and as this is illustrated in FIG. 2, a key root database should be established in the transmitter designated by the general reference 1 and the receiver designated by the general reference 2 during a step designated by the general reference 5.

According to the exemplary embodiment illustrated in this figure, this step 5 for establishing in the transmitter and the receiver this key root database consists in a first phase, in the transmitter 1 of generating an information sequence called a seed, this generation step being designated by the general reference 6 and being applied by a corresponding generator.

This type of information sequence called a seed is well-known in cryptographic methods.

This seed information sequence is then transmitted during a step 7 by the transmitter to the receiver 2, the latter then having for example a copy of the seed information sequence in 8.

The transmitter and the receiver then apply a step for deriving the key root database from this seed information sequence.

These steps are designated by the references 9 and 10, for the derivation steps applied by the transmitter and the receiver respectively.

In fact, this step for having the key database derived from the seed sequence by the transmitter and the receiver may apply a cryptographic method by for example using conventionally a hash function or further a pseudo-random generator with which it is possible to pass from the seed to the key root database in a conventional way.

It should be noted that according to the exemplary embodiment illustrated in this figure, the transmission of the seed sequence between the transmitter and the receiver is accomplished during step 7 on a secured channel between the latter.

Thus, for example the information transmitted on this channel may be ciphered by using ciphering and deciphering means of a conventional type 11 and 12, respectively, associated with the transmitter and the receiver.

In the method according to the invention, provision is also made for a step for generating in the transmitter a sequence of bits called an index.

This step is designated by the general reference 13 in FIG. 2 and this index bit sequence may for example have a length of 32 or 64 bits.

This index bit sequence is then transmitted by the transmitter to the receiver, during step 14, the receiver then having in 15, for example a copy of this index bit sequence.

The transmitter and the receiver then each have an identical key root database and an identical index bit sequence which are used for having the ciphering/deciphering key extracted from the index and from the key root database by this transmitter and by this receiver, as this is illustrated by steps 16 and 17 for the transmitter and for the receiver respectively.

The result of this extraction step is the ciphering key delivered in 18 for the transmitter and the deciphering key delivered in 19 for the receiver.

The step 16, 17, applied by the transmitter and the receiver for extracting the key from the index and the key root database, may be carried out for example by an injective derivation algorithm, i.e. according to which two different indexes give two different keys

Of course, it is understood that other embodiments may be contemplated.

Thus, for example in FIG. 2, a transmission of the seed information sequence is illustrated over a secured i.e. ciphered channel.

Of course, the index bit sequence may also be transmitted over a channel of this type.

Also, in this figure, an embodiment is described in which the seed information sequence is transmitted from the transmitter to the receiver so that the key root database may be formed in this receiver.

Of course, according to another exemplary embodiment, this key root database may be generated only in the transmitter and transmitted through this transmitter to the receiver directly, for example through a secured channel.

It is then understood that such a method has a certain number of advantages notably as regard to increased security of the ciphering of the information and the ease in changing the keys.

Indeed, instead of having to transmit a new key of 128, 192 or 256 bits to all the relevant receivers, as a replacement for the old key, it is sufficient for the transmitter to transmit to these receivers, the index bit sequence so that they may calculate the new key.

Now, as this was mentioned earlier, this index bit sequence may be much smaller than a key.

Indeed and as this was mentioned earlier, this index sequence may for example have a length of 32 or 64 bits which is much faster to transmit, consumes much less bandwidth, etc. . . . , than the transmission of a key with 128, 192 or 256 bits.

An increase in the renewal frequency of the keys may then be contemplated.

Moreover, it may also be contemplated to renew the key root database. This may also be achieved simply by transmitting a new seed from the transmitter to the receiver, this seed also having reduced size relatively to the key root base.

Of course, other further embodiments may be contemplated.

While the foregoing is directed to embodiments of the present invention, other and further embodiments of the invention may be devised without departing from the basic scope thereof, and the scope thereof is determined by the claims that follow.

1. A method for sharing an information ciphering/deciphering key between a transmitter and at least one receiver, wherein the method includes the following steps:
a step for establishing in the transmitter and said at least one receiver, a key root database,
a step for generating in the transmitter a sequence of bits called an index,
a step for having this index bit sequence transmitted by the transmitter to the receiver, and
a step for having the key extracted from the index and the key root database by the transmitter and said at least one receiver.

2. The method for sharing an information ciphering/deciphering key according to claim 1, wherein the step for establishing the key root database includes a step for generating the latter in the transmitter and a step for having the latter transmitted by the transmitter to the receiver.

3. The method for sharing an information ciphering/deciphering key according to claim 2, wherein the step for transmitting the key root database and/or the step for transmitting the index bit sequence are carried out on a secured channel between the transmitter and the receiver.

4. The method for sharing an information ciphering/deciphering key according to claim 1, wherein the step for establishing the key root database includes:
a step for generating in the transmitter an information sequence called a seed,
a step for having this seed information sequence transmitted by the transmitter to the receiver, and
a step for having the key root database derived from this seed information sequence by the transmitter and the receiver.

5. The method for sharing an information ciphering/deciphering key according to claim 4, wherein the step for having the key database derived by the transmitter and the receiver applies a cryptographic method.

6. The method for sharing an information ciphering/deciphering key according to claim 5, wherein the cryptographic method applies a hash function.

7. The method for sharing an information ciphering/deciphering key according to claim 5, wherein the cryptographic method applies a pseudo-random generator.

8. The method for sharing an information ciphering/deciphering key according to claim 4, wherein the transmission of the seed information sequence and/or the transmission of the index bit sequence are carried out over a secured channel.

9. The method for sharing an information ciphering/deciphering key according to claim 1, wherein the step for having the key extracted from the index and the key root database by the transmitter and said at least one receiver, is carried out by an injective derivation algorithm.

10. The method for sharing an information ciphering/deciphering key according to claim 1, wherein the index bit sequence has a length of 34 bits and the key a length of 128, 192 or 256 bits.

11. A system for sharing an information ciphering/deciphering key between a transmitter and at least one receiver for applying a method according to claim 1, wherein the system includes:
means for establishing a key root database in the transmitter and said at least one receiver,
means for generating in the transmitter a sequence of bits called an index,
means for having this index bit sequence transmitted by the transmitter to the receiver, and
means for having the key extracted from the index and the key root database by the transmitter and said at least one receiver.

12. A system for controlling access to pay television signals, wherein it includes at least one system according to claim 11.
